(19) United States
(12) Patent Application Publication
(10) Pub. No.: US 2018/0317681 A1
(43) Pub. Date: Nov. 8, 2018

(54) SINGLE PIECE, SHORT STEMMED BLOWN DRINKING VESSEL AND METHOD OF MANUFACTURING THE SAME

(71) Applicant: Parameshwar R. Yanamandra, Vancouver, WA (US)

(72) Inventor: Parameshwar R. Yanamandra, Vancouver, WA (US)

(21) Appl. No.: 15/972,505

(22) Filed: May 7, 2018

Related U.S. Application Data
(60) Provisional application No. 62/503,228, filed on May 8, 2017.

(51) Int. Cl. A47G 19/22; B65D 77/20; B65D 85/72; C03B 9/33; C03B 19/02; B29C 49/06

(52) U.S. Cl. CPC A47G 19/2205; B65D 77/2024; B65D 85/72; B29L 2031/7132; C03B 19/025; B29C 49/06; B29B 2911/14366; C03B 9/33

(57) ABSTRACT

Disclosed is a one-piece, short stemmed, blow molded drinking vessel. The vessel includes a stem with a first end and a second end, a partial hollow cavity disposed therein, and a height that allows holding of the stem using a fore finger and a thumb, a bowl with a lip configured on top, and has a continuous bowl surface that laterally stretches between the lip to its maximum predefined diameter, thereafter shrinks to merge with the first end of the stem forming a beverage retaining region, a base with a predefined diameter, the second end of the stem is merged centrally over a top surface of the base, and a removable sealing unit adapted for covering the lip of the bowl in order to ensure the beverage contained within the beverage retaining region doesn't come in contact with air and doesn't spill out during transportation.

### CROSS-REFERENCE TO RELATED APPLICATION

The present application claims the priority benefits of U.S. Provisional Application No. 62/503,228, filed on May 8, 2017, which is incorporated herein by reference in its entirety.

### FIELD OF THE INVENTION

The present disclosure relates to the field of drinking vessels. More particularly, present disclosure relates to a single piece, short stemmed, integral blow molded beverage vessel used as single serve drinking vessel or drinking vessel for regular uses, and a method for manufacturing the same.

### BACKGROUND

Single serve beverage vessels, especially wine glasses provided with wide or narrow openings with a releasable lid over their opening are well known in the art. Further, the beverage vessels/containers come in different shapes and sizes and could be made of crystal or plastic or other material. Beverage containers, especially the wine glasses are made to present bouquet of a particular wine in a particular way. Thus, a glass for a white wine will have a narrow shape to concentrate the thin bouquet of the white wine. Similarly, a glass for a red wine has a wider shape to let the stronger bouquet disperse. Thus, makers of wine glasses or like beverage containers generally practice variations on these major themes known to them or practice variations based on type of wines.

Speaking about single serve wine drinking glasses, it has been acquired traditionally to have a stem in the wine glass apart from a bowl section that holds the wine and a base or foot section that provides support to the glass, when the glass is placed over a surface in an upright position. There are various reasons known to people that makes the stem a preferred part in the wine glasses or similar glasses, for example, presence of the stem provides an elegant look to the glass, allows to keep hand away and prevent warming the wine/beverage contained in the glass, avoid smearing the bowl section that hold the wine/beverage with greasy fingerprints and so on. Thus, having the stem in the wine glass is highly preferred by consumers.

Currently available single serve wine glasses are not very stable when they are used in a production line for prefilling the beverages or wine therein, especially currently available wine glasses tend to have larger stem and such glasses during their movement in the production line tend to spill or fall leading to breakage of the glasses. The larger stem creates a high center of gravity when the glass is prefilled for packaging in the production line. Consequently, a comparatively small tipping force can spill the content in the glass. The problem is exacerbated when the surface upon which the wine glass is resting is slightly uneven or is moving (for example in the production line).

In order to overcome the above shortcomings with larger stemmed glasses in the production lines, several inventors in the past proposed several beverage container designs that could eliminate the stem section and the base section to get blown wine glasses. Further, some of inventors proposed cylindrical shaped bowl right from top opening of the glass to the base of the bowl in order to ease the manufacturing of such glasses using the existing molding processes. Although, such designs could solve the shortcomings, however, the elimination of the stem and the base sections from the glasses also eliminates the aesthetic look of the glasses, leading to a loss of consumer interest on such glasses.

Furthermore, lots of existing beverage containers or single serve beverage containers, especially wine glasses are manufactured or designed in a way to have the bowl section, the foot section and the stem section as separate two or three parts, which are then assembled together using known methods to form the glass ready for use or prefilling in the production line. In one hand, manufacturing the bowl section, the foot section and the stem section as two or three separate parts increases production cost, and on the other hand, it brings in several manufacturing challenges when the parts are manufactured separately and then attached to each other to form the glass. For example, there are chances that the stem warps up or some air bubbles get formed within the stem during the process of such manufacturing.

Some of the examples include, WO2008020301 that discloses a two part drinking vessel comprising of a receptacle for holding a beverage and a base. The receptacle includes a cup portion and a hollow neck portion defining a filler opening closable by means of a stopper and through which the receptacle can be fitted onto the base by means of screwing mechanism.

Further, US20170135508 discloses about formation of the glass in possibly two or three parts and then physical attachment of the stem to the bowl or to the foot, or to both, by using suitable adhesive, or by thermal or mechanical attachment.

In the light of aforementioned background, there is a need for a single piece beverage drinking vessel, especially a wine glass that can provide more stability when used in a production line for prefilling the beverage/wine therein. The invention further proposes a single serve beverage glass or a beverage glass in general with relatively short stem that leads to no compromisation with respect to aesthetic looks of the glass, and is able to meet the different manufacturing challenges besides being affordable.

### BRIEF SUMMARY

It is an objective of the present invention to provide a single serve beverage container or a beverage glass for regular uses, especially a wine glass that's esthetic, compact and sturdy that can provide more stability and can withstand rigors of a production line when the glasses are prefilled with beverages, especially when such glasses are made of plastic or glass material.

It is another objective of the present invention to provide a stemware for regular uses or a single serve beverage container for drinking, especially a wine glass with a short stem (with height just enough to hold the stem using a thumb and a fore finger), that lowers center of gravity when the glass is being prefilled in the production line thereby preventing spill or fall of the glass especially when the glass is resting on uneven surface or moving in the production line.

It is another objective of the present invention to provide the beverage container or the wine glass with a partially hollow stem or stem with a hollow cavity formed therein in order to avoid or overcome manufacturing challenges. The partially hollow stem of the glass not only increases beverage volume capacity of the glass but also aids in avoiding warping of the stem and formation of bubbles within the stem.

It is yet another objective of the present invention to provide the beverage container or the wine glass that's formed as a single piece, thereby making the beverage container more affordable.

It is yet another objective of the present invention to provide a single piece beverage container or the wine glass with a bowl, a stem and a base, wherein the diameter of the base is preferably made more than the diameter of a lip formed on the top of the bowl, and lesser than the diameter of a belly of the blow, giving rise to an aesthetically blown glass design and more stability to the beverage container.

According to an aspect of the present invention, there is provided a one-piece, integral blow molded beverage vessel used as a single serve drinking vessel, the beverage vessel, comprising a stem with a first end and a second end, wherein the stem comprises of a partial hollow cavity extending in a direction from the first end to the second end, and a height substantial enough to allow holding of the stem using a fore finger and a thumb; a bowl with a lip having a predefined diameter configured on top, wherein the bowl comprises of a continuous bowl surface that laterally stretches between the lip to a maximum predefined diameter of the bowl, thereafter shrinks to merge with the first end of the stem forming a beverage retaining region with capability of holding a predetermined volume of beverage; a base with a predefined diameter, wherein the second end of the stem is merged centrally over a top surface of the base; and a removable sealing unit adapted for covering the lip of the bowl in order to ensure the beverage contained within the beverage retaining region doesn't come in contact with air and doesn't spill out during transportation.

According to another aspect of the present invention, there is provided a method of manufacturing a single piece, short stemmed blown drinking vessel used as a single serve drinking vessel, the method comprising the steps of: providing, a first mold; injecting a fusible material used for forming the drinking vessel into the first mold; cooling the fusible material injected inside the first mold to form a preform, wherein the preform comprises of: a base with a predefined diameter, a bowl substantially canonical in shape with tapered bottom with a lip on top with a predefined diameter, and a stem with a first end and a second end, wherein the stem comprises of a partial hollow cavity extending in a direction from the first end to the second end, and a height substantial enough to allow holding of the stem using a fore finger and a thumb; removing the preform out of the first mold; providing a second mold; placing the preform inside the second mold; heating, and blowing the preform to form the drinking vessel comprising: the stem with the first end and the second end, wherein the stem comprises of a partial hollow cavity extending in a direction from the first end to the second end, and the height essential to allow holding of the stem using the fore finger and the thumb, the bowl with the lip having the predefined diameter configured on the top thereof, wherein the bowl comprises of a continuous bowl surface that laterally stretches between the lip to a maximum predefined diameter, thereafter shrinks to merge with the first end of the stem forming a beverage retaining region with capability of holding a predetermined volume of beverage, and the base with the predefined diameter, wherein the second end of the stem is merged centrally over a top surface of the base; and covering the lip of the bowl using a removable sealing unit in order to ensure the beverage contained within the beverage retaining region doesn't come in contact with air and doesn't spill out during transportation.

These and other features and advantages of the invention will become apparent from the detailed description below, in light of the accompanying drawings.

### BRIEF DESCRIPTION OF THE ACCOMPANYING DRAWINGS

The novel features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention.

Embodiments of this disclosure will now be described by way of example in association with the accompanying drawings in which:

FIG. 1 shows a top perspective view of a single piece, short stemmed, integral blow molded beverage vessel of the present invention, in accordance with an embodiment.

FIG. 2 shows a cross sectional side view of the beverage vessel shown in the FIG. 1.

FIG. 3 shows a top view of the beverage vessel shown in the FIG. 1.

FIG. 4 shows a bottom view of the beverage vessel shown in the FIG. 1.

FIG. 5-6 shows the beverage vessel of the FIG. 1 prefilled with the beverage therein, covered with a removable sealing unit and held on hand using a thumb and his fore finger by a user, in accordance with an embodiment of the present invention.

FIG. 7 shows a representative preform formed during the process of manufacturing, which is then transformed into the beverage vessel of the FIG. 1, in accordance with an embodiment of the present invention.

### DETAILED DESCRIPTION

The single piece, short stemmed, integral blow molded beverage container used as a drinking vessel and a method for manufacturing the same will now be described with reference to the accompanying drawings which should be regarded as merely illustrative without restricting the scope and ambit of the disclosure.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

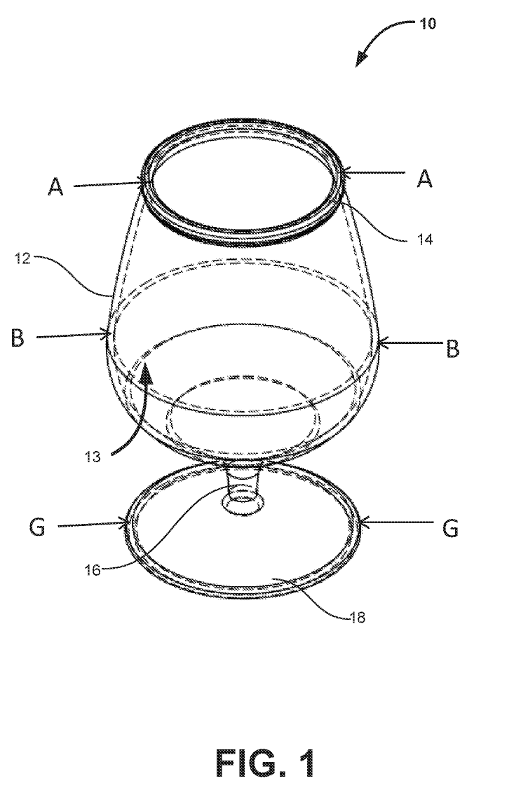

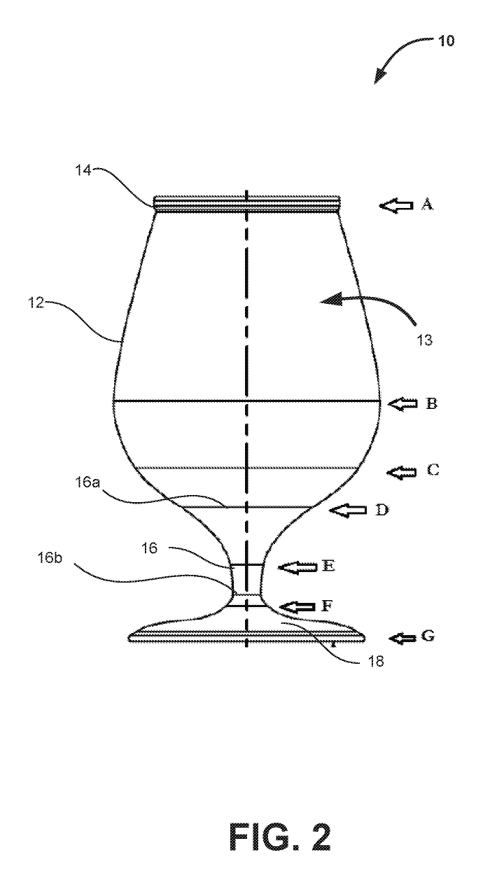

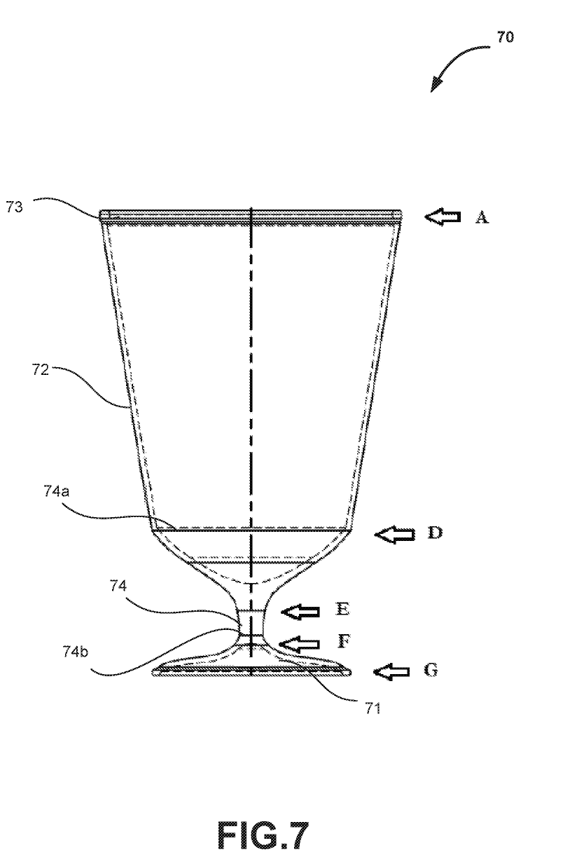

For the purpose of description, the terms “beverage container”, “drinking vessel”, “glass”, “drinking glass”, “wine glass”, “beverage glass”, “single serve beverage glass” or “a single serve beverage container” and any variations thereof are all used interchangeably to refer to the invention and should not be considered in any other sense. Further, in the accompanying FIG. 1, FIG. 2 and FIG. 7, the arrow marks A to G are used to represent imaginary/hypothetical lines or points on the beverage vessel as a basis for reference to understand the invention in a better manner and thus should be accordingly considered for the purpose of this disclosure.

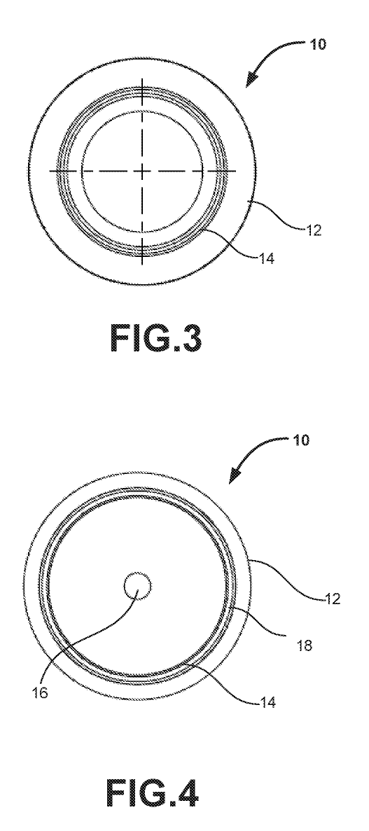

Although any systems and methods similar or equivalent to those described herein can be used in the practice or testing of embodiments of the present invention, the preferred systems and methods are now described with respect to FIG. 1 through FIG. 7.

Referring to accompanying drawings, specifically to FIGS. 1-6, there is shown a beverage vessel/container 10 used for drinking. The term “ beverage vessel” as used herein preferably refers to but not limited to a “wine glass” or a “glass” used for prefilling the beverages in a production line for use as a single serve beverage glass. Although the beverage container as described herein is a single serve meant for uses during travel or in different events, parties and the like, it should be understood that one can use the beverage vessel 10 of the present invention in the homely environment as well. Further, although the glass 10 as described herein is used to hold alcoholic beverage, for example wine 20, it should be understood that the glass 10 may be used for holding or packaging of any other types of beverages, such as for example, juices.

Further, in the context of present invention, although the invention is described in terms of possibility to make the glass using plastic material, it should be understood that different material can be used for manufacturing of the proposed glass, such as crystal material, plastic material, regular glass material, or any other material commonly available commercially.

As seen in the FIGS. 1-5, the beverage vessel 10 includes a stem 16 with a first end 16a and a second end 16b. The stem 16 is partially hollow to form a partial hollow cavity (D to E) extending in a direction from the first end 16a to the second end 16b as shown in the FIG. 2. The stem 16 is made partially hollow along its length to avoid warping/bending of the stem 16 and formation of any bubbles within the stem 16 during process of manufacturing especially when the beverage vessels are made of plastic material. Warping of stems is a common manufacturing challenge, in the existing stemware glass manufacturing industry now days. The prior art stemware glasses, tend to have non hollow stems, and thus the cooling time length of the material used for stem 16 varies from one end 16a to the other end 16b of the stem 16 and thus the stem 16 fails to get cooled faster throughout the stem's length in equal proportion of time resulting in warping of stems and formation of bubbles within the stems especially when the stemware glasses are kept in upright (vertical) or in the sideways (horizontal) positions. The current invention addresses this issue effectively with partial hollow stem 16. In the current invention, as the stem 16 is made partially hollow (D to E), and only a portion of the stem 16 is non hollow (E to F), due to which the stem 16 gets cooled faster throughout its length, thus when the beverage glass 10 is kept in upright or sidewise position during manufacturing, the stem 16 doesn't get warped unlike conventional stemware having non hollow stems.

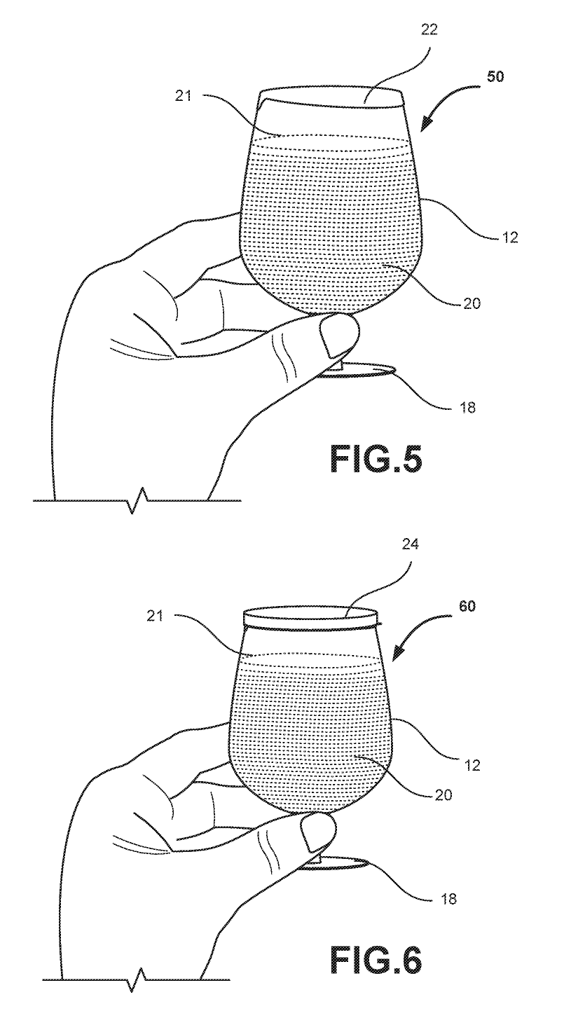

The stem 16 has a height substantial enough to allow holding of the stem 16 using a fore finger and a thumb of a user as shown in the FIGS. 5-6. The stem 16 extends from the first end 16a to the second end 16b with varying diameters. The first end 16a of the stem 16 is wider in diameter compared to the second end 16b which is narrower that merges centrally over a top surface of a base 18.

The beverage vessel 10 further includes a bowl 12 with a lip 14 on its top. The lip 14 consists of a predefined diameter (marked as A, in FIG. 1-2). The lip 14 is made flat or may be rounded with a substantial surface area to facilitate prefilling of a beverage retaining region (A to E) of the beverage container 10 when the container 10 is being used in the production line. Further, the lip 14 with flat surface also facilitates in forming a seal over the lip 14 using a removable sealing unit 22, 24, which will be better described at later section of this disclosure.

The bowl 12 further includes a continuous bowl surface 13 that laterally stretches between the lip 14 to a maximum predefined diameter or belly region (the diameter marked at point B in the FIG. 1-2) of the bowl 12, and thereafter shrinks to merge with the first end 16a of the stem 16 forming a beverage retaining region (area from A to E) with capability to hold a predetermined volume of beverage. The maximum predetermined volume of beverage that can be accommodated in the beverage retaining region (A to E) is about 213 ml, according to the embodiment of the present invention; however, one should understand the size of the beverage glass 10 can be changed in order to increase or decrease the volume content. In an example, for the purpose of utility, a portion of the volume content that can accommodate into the beverage retaining region (A to E) can be left empty such as to have a standard volume packed/filled inside the beverage vessel 10 and allow any needed space for expansion of beverage content in the glass 10. The portion of the volume content that is preferably left empty can be seen in the FIG. 5-6, it is region from lip 14 to the top surface 21 of the beverage. The standard volume packed/filled inside the beverage vessel is about 187 ml considering the beverage to be wine 20 in this example. However, it should be noted that, any volume of beverage 20 lesser and equal to the predetermined volume of beverage that can be accommodated inside the beverage retaining region of the glass 10 based on types of beverage 20 being used.

The beverage vessel 10 further includes a base 18 with a predefined diameter (marked with arrows G in the FIG. 1 and FIG. 2). The second end 16b of the stem 16 is merged centrally over a top surface of the base 18. The predefined diameter of the base 18 is made smaller than the maximum predefined diameter (marked as B) of the bowl 12 and greater than the predefined diameter (marked as A) of the lip 14 to provide stability to the beverage container/vessel 10 against any movement during a prefilling process in the production line. Also, such choice of diameters helps in stacking up of glasses for storage purpose.

The beverage vessel 10 further includes a removable sealing unit 22, 24. The removable sealing unit consists of a foil 22 as shown in the FIG. 5, and a cap 24 that can be placed over the foil 22 as shown in the FIG. 6.

In the context of present invention, two layer sealing is applied over the lip 14 of the glass 10 to ensure the beverage 20 contained within the beverage retaining region doesn't come in contact with air and doesn't spill out during transportation etc. It should be understood that, even different other single layer sealing method can be applied over the proposed beverage glasses with or without some design modification related to the lip 14. For example, a peel of layer with strong bond formation feature may alone be used over the lip 14, or any cap with locking features that engages with the lip 14 can be used for sealing the lip 14.

Furthermore, according to an embodiment, in a scenario, when the above described beverage vessel 10 is not used as a single serve beverage glass. The proposed beverage vessel can be used as a regular beverage glass or a glass with or without a removable sealing unit 22, 24, preferably without a removable sealing unit 22, 24. For example, when used by users in their home.

Further, there is provided a method of manufacturing the proposed beverage vessel 10. Unlike the existing stemware glasses, wine glasses, or other beverage containers with the stem, that require different parts such as a bowl, a stem and a base to be made or manufactured separately and then attached or assembled together, the present invention proposes a method for manufacturing the proposed blown beverage vessel 10 as one piece unitary component, with a short stem 16 with higher stability without compromising the aesthetic appearance of the beverage vessel 10 and at the same time could be very cost effective as it could eliminate the need to separately manufacture various parts of the beverage vessel.

The method of manufacturing a single piece, short stemmed blown drinking vessel 10 used as a single serve drinking vessel will now be described in detail along with some reference to the FIGS. 1-6 discussed above and FIG. 7. The method includes a step of providing a first mold (not shown). The method then includes a step of injecting a fusible material used for forming the drinking vessel 10 into the first mold. The fusible material used for forming the drinking vessel comprises of but not limited to plastic material, crystal material or glass material.

The method then includes a step of cooling the fusible material injected inside the first mold to form a preform 70 as represented in the FIG. 7. The preform 70 basically includes all of the components similar to what is describes above with respect to FIGS. 1-6, however, the bowl 72 part is substantially canonical with tapered bottom rather than being blown as shown in the FIG. 1. The preform 70 includes a base 71 with a predefined diameter (marked as G), similar to the base 18 of the beverage container 10 described above. The preform 70 further includes the bowl 72 substantially canonical with tapered bottom in shape with a lip 73 on top with a predefined diameter (marked as A), similar to the lip 14 described above with reference to the beverage vessel 10, with just difference in the shape of the bowl 73. The preform 70 further includes a stem 74 with a first end 74a and a second end 74b. The stem 74 is made partially hollow to include a partial hollow cavity extending in the direction from the first end 74a to the second end 74b, and a height essential to allow holding of the stem using a fore finger and a thumb by a user.

The step of manufacturing then includes a step of removing the preform 70 out of the first mold. The method further includes providing a second mold (not shown). The second mold is preferably a blow mold where the heating and blowing is carried out over the formed preform 70, which is referred to as “integrated blow mold process” for the purpose of this invention. The glass could be blown by various means, for example pumping continuously hot air inside or by means of any known processes. The integrated blow mold process includes a step of placing the preform 70 inside the second mold. The integrated blow mold process further includes steps of heating, and blowing the preform 70 to transform the preform 70 into the drinking vessel 10 as shown and described with reference to FIGS. 1-6 above.

Although the manufacturing process as described herein, is implemented as a two step method using two different molds, the first mold and the second mold. First mold to carry out injection molding process in order to form preform 70, and then second mold used to carry out the integral blow molding processing to form a blown shaped glass as a final product, it should be apparent to the person skilled in the art that with advancements in the technology, person in the field, can visualize use of a single mold (instead of using two different molds), to carry out combined injection molding and the integral blow process.

Further the method includes a step of covering or sealing the lip 14 of the beverage vessel 10 outputted from the integrated blow mold process. The covering or sealing is preferably done using a removable sealing unit 22, 24 in order to ensure the beverage contained within the beverage retaining region doesn't come in contact with air and doesn't spill out during transportation.

Although the present invention is described with respect to manufacturing of proposed beverage vessel 10, it should be understood that the proposed process can be used to form beverage glasses of varying shapes and sizes as well and thus the disclosure here should not be considered limited to the exemplary embodiments and processes described herein.

Although particular embodiments of the invention have been described in detail for purposes of illustration, various modifications and enhancements may be made without departing from the spirit and scope of the invention.

What is claimed is:

1. A one-piece, integral blow molded beverage vessel used as a single serve drinking vessel, the beverage vessel, comprising:
a stem with a first end and a second end, wherein the stem comprises of a partial hollow cavity extending in a direction from the first end to the second end, and a height substantial enough to allow holding of the stem using a fore finger and a thumb;
a bowl with a lip having a predefined diameter configured on top, wherein the bowl comprises of a continuous bowl surface that laterally stretches between the lip to a maximum predefined diameter of the bowl, thereafter shrinks to merge with the first end of the stem forming a beverage retaining region with capability of holding a predetermined volume of beverage;
a base with a predefined diameter, wherein the second end of the stem is merged centrally over a top surface of the base; and
a removable sealing unit adapted for covering the lip of the bowl in order to ensure the beverage contained within the beverage retaining region doesn't come in contact with air and doesn't spill out during transportation.

2. The beverage vessel of claim 1, wherein the removable sealing unit comprises at least one of a foil, and a cap.

3. The beverage vessel of claim 1, wherein the lip is made flat to facilitate prefilling of the beverage retaining region of the beverage vessel, and allow formation of a seal thereof using the removable sealing unit.

4. The beverage vessel of claim 1, wherein the lip is made rounded with a substantial surface area to facilitate prefilling of the beverage retaining region of the beverage vessel, and allow formation of a seal thereof using the removable sealing unit.

5. The beverage vessel of claim 1, wherein the predefined diameter of the base is smaller than the maximum predefined diameter of the bowl and greater than the predefined diameter of the lip to provide stability to the beverage vessel against any movement during a prefilling process in a production line.

6. The beverage vessel of claim 1, wherein the stem extends from the first end to the second end with varying diameters.

7. The beverage vessel of claim 6, wherein the first end of the stem is wider in diameter compared to the second end which is narrower and merged centrally over the top surface of the base.

8. The beverage vessel of claim 1, wherein the predetermined volume of beverage that can be held in the beverage retaining region is about 213 ml substantially greater than intended standard measure of 187 ml used for serving wine.

9. A method of manufacturing a single piece, short stemmed blown drinking vessel used as a single serve drinking vessel, the method comprising the steps of:
providing, a first mold;
injecting a fusible material used for forming the drinking vessel into the first mold;
cooling the fusible material injected inside the first mold to form a preform, wherein the preform comprises of: a base with a predefined diameter, a bowl substantially canonical with tapered bottom in shape with a lip on top with a predefined diameter, and a stem with a first end and a second end, wherein the stem comprises of a partial hollow cavity extending in a direction from the first end to the second end, and a height substantial enough to allow holding of the stem using a fore finger and a thumb;
removing the preform out of the first mold;
providing a second mold;
placing the preform inside the second mold;
heating, and blowing the preform to form the drinking vessel comprising: the stem with the first end and the second end, wherein the stem comprises of a partial hollow cavity extending in a direction from the first end to the second end, and the height essential to allow holding of the stem using the fore finger and the thumb, the bowl with the lip having the predefined diameter configured on the top thereof, wherein the bowl comprises of a continuous bowl surface that laterally stretches between the lip to a maximum predefined diameter, thereafter shrinks to merge with the first end of the stem forming a beverage retaining region with capability of holding a predetermined volume of beverage, and the base with the predefined diameter, wherein the second end of the stem is merged centrally over a planar surface of the base; and
covering the lip of the bowl using a removable sealing unit in order to ensure the beverage contained within the beverage retaining region doesn't come in contact with air and doesn't spill out during transportation.

10. The method of claim 9, wherein the fusible material used for forming the drinking vessel comprises of plastic material, crystal material or glass material.

11. The method of claim 9, wherein the removable sealing unit adapted for covering the lip of the bowl of the beverage vessel comprises at least one of a foil, and a cap.

12. The method of claim 9, wherein the lip is made flat to facilitate prefilling of the beverage retaining region of the beverage vessel, and allow formation of a seal thereof using the removable sealing unit.

13. The method of claim 9, wherein the lip is made rounded with a substantial surface area to facilitate prefilling of the beverage retaining region of the beverage vessel, and allow formation of a seal thereof using the removable sealing unit.

14. The method of claim 9, wherein the predefined diameter of the base is smaller than the maximum predefined diameter of the bowl of the beverage vessel and greater than the predefined diameter of the lip to provide stability to the beverage vessel against any movement during a prefilling process in a production line.

15. The method of claim 9, wherein the stem extends from the first end to the second end with varying diameters.

16. The method of claim 15, wherein the first end of the stem is wider in diameter compared to the second end which is narrower and merged centrally over the top surface of the base.

17. The method of claim 1, wherein the predetermined volume of beverage that can be held in the beverage retaining region of the beverage vessel is about 213 ml substantially greater than intended standard measure of 187 ml used for serving wine.

18. A beverage glass, comprising:
a stem with a first end and a second end, wherein the stem comprises of a partial hollow cavity extending in a direction from the first end to the second end, and a height substantial enough to allow holding of the stem using a fore finger and a thumb;
a bowl with a lip having a predefined diameter configured on top, wherein the bowl comprises of a continuous bowl surface that laterally stretches between the lip to a maximum predefined diameter of the bowl, thereafter shrinks to merge with the first end of the stem forming a beverage retaining region with capability of holding a predetermined volume of beverage; and
a base with a predefined diameter, wherein the second end of the stem is merged centrally over a top surface of the base.
